(19) United States
(12) Patent Application Publication
(10) Pub. No.: US 2026/0167173 A1
(43) Pub. Date: Jun. 18, 2026

(54) TRANSMISSION INPUT TORQUE CONTROL APPARATUS

(71) Applicant: SUBARU CORPORATION, Tokyo (JP)

(72) Inventors: Akihiro NABESHIMA, Tokyo (JP); Yoshinobu YAMAZAKI, Tokyo (JP); Keigo YAMADA, Tokyo (JP); Takeshi YONEDA, Tokyo (JP); Takumi ARAKI, Tokyo (JP); Shuntaro MIURA, Tokyo (JP); Yoshiyuki JIN, Tokyo (JP); Fumiya SATO, Tokyo (JP); Hiroshi KUSANO, Tokyo (JP)

(21) Appl. No.: 19/530,882

(22) Filed: Feb. 5, 2026

Related U.S. Application Data
(63) Continuation of application No. PCT/JP2023/033733, filed on Sep. 15, 2023.

(51) Int. Cl. B60W 20/00; B60K 6/46; B60W 10/02; B60W 10/06; B60W 10/08; B60W 10/11; B60W 30/188

(52) U.S. Cl. CPC B60W 20/00; B60K 6/46; B60W 10/026; B60W 10/06; B60W 10/08; B60W 10/11; B60W 30/188; B60W 2510/0275; B60W 2510/0638; B60W 2540/10; B60W 2710/024; B60W 2710/06; B60W 2710/08; B60W 2710/1005; B60W 2710/1022; B60Y 2200/92

(57) ABSTRACT

A transmission input torque control apparatus includes an engine, a torque converter, a motor generator, an automatic transmission, and a control unit. When a predetermined learning condition is satisfied, the control unit causes the motor generator to perform a regenerative operation, detects an output torque of the torque converter from a regenerative electric power generation amount of the motor generator, and performs learning of, based on the output torque and an engine speed at a time of detection, a value of “capacity coefficient×torque ratio” of the torque converter. After the learning, the control unit estimates a torque to be inputted to the automatic transmission based on the learned value of “capacity coefficient×torque ratio” and an engine speed in real time, and so controls the engine that the estimated input torque does not exceed an upper limit value of an input allowable torque of the automatic transmission.

### CROSS-REFERENCE TO RELATED APPLICATIONS

This application is continuation of International Application No. PCT/JP2023/033733, filed on Sep. 15, 2023, the entire contents of which are hereby incorporated by reference.

### BACKGROUND

The disclosure relates to a transmission input torque control apparatus that controls torque to be inputted to a transmission.

Japanese Unexamined Patent Application Publication No. 2006-170116 discloses an engine torque control apparatus that performs control to reduce an engine torque in a situation where an input torque to a transmission becomes excessively large, in order to protect the transmission. In the engine torque control apparatus, when an engine output torque that is inputted to the transmission exceeds an allowable upper limit torque of the transmission, a control value for a torque to be generated by an engine is set to make the input torque to the transmission to become smaller than the allowable upper limit torque.

Incidentally, in general, a value of such an allowable upper limit torque that limits the input torque to the transmission is set with a margin. That is, for example, the margin is so set that the input torque to the transmission does not exceed a limit of the transmission even in a case of an upper limit product (a worst case) taking into consideration a width of individual variation of, for example, engines and torque converters, and estimation accuracy of the engine torque.

### SUMMARY

An aspect of the disclosure provides a transmission input torque control apparatus including an engine, a torque converter, a motor generator, an automatic transmission, and a control unit. The engine is configured to output an engine torque. The torque converter is coupled to an output shaft of the engine, and configured to transmit the engine torque via oil and perform torque amplification. The motor generator is coupled to an output shaft of the torque converter, and configured to operate as a motor that outputs a motor torque upon driving and operate as a generator upon regeneration. The automatic transmission is coupled to an output shaft of the motor generator, and configured to convert an inputted torque and output the converted torque. The control unit is configured to control the engine, the torque converter, the motor generator, and the automatic transmission. The control unit is configured to, when a predetermined learning condition is satisfied, cause the motor generator to perform a regenerative operation, detect an output torque of the torque converter from a regenerative electric power generation amount of the motor generator, and perform learning of, based on the output torque and an engine speed at a time of detection, a value of a transmission characteristic of the torque converter. The control unit is configured to, after the learning, estimate a torque to be inputted to the automatic transmission based on the learned value of the transmission characteristic of the torque converter and an engine speed in real time, and so control the engine that the estimated input torque does not exceed an upper limit value of an input allowable torque of the automatic transmission.

An aspect of the disclosure provides a transmission input torque control apparatus including an engine, a torque converter, a motor generator, an automatic transmission, and circuitry. The engine is configured to output an engine torque. The torque converter is coupled to an output shaft of the engine, and configured to transmit the engine torque via oil and perform torque amplification. The motor generator is coupled to an output shaft of the torque converter, and configured to operate as a motor that outputs a motor torque upon driving and operate as a generator upon regeneration. The automatic transmission is coupled to an output shaft of the motor generator, and configured to convert an inputted torque and output the converted torque. The circuitry is configured to control the engine, the torque converter, the motor generator, and the automatic transmission. The circuitry is configured to, when a predetermined learning condition is satisfied, cause the motor generator to perform a regenerative operation, detect an output torque of the torque converter from a regenerative electric power generation amount of the motor generator, and perform learning of, based on the output torque and an engine speed at a time of detection, a value of a transmission characteristic of the torque converter. The circuitry is configured to, after the learning, estimate a torque to be inputted to the automatic transmission based on the learned value of the transmission characteristic of the torque converter and an engine speed in real time, and so control the engine that the estimated input torque does not exceed an upper limit value of an input allowable torque of the automatic transmission.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the disclosure.

FIG. 1 is a block diagram illustrating a configuration of a transmission input torque control apparatus according to an embodiment and a main part of a hybrid electric vehicle to which the transmission input torque control apparatus is applied.

FIG. 2 is a graph illustrating an example of a performance curve of a torque converter.

FIG. 3 is a graph for describing how to obtain learning data of “capacity coefficient×torque ratio” with respect to a speed ratio.

FIG. 4 is a graph for describing a method of estimating an output torque using the learning data.

FIG. 5 is a flowchart illustrating a processing procedure of a transmission input torque control performed by the transmission input torque control apparatus according to the embodiment.

### DETAILED DESCRIPTION

Incidentally, detection accuracy of a torque outputted from an engine and a torque converter (that is, a torque to be inputted to a transmission) has been low, and a margin has been set to be larger. In contrast, because a degree of individual variation or the like differs for each engine or each torque converter, when the margin is large, there arises a case where an output torque of the engine or the like is unnecessarily (excessively) limited (that is, an allowable upper limit torque of the transmission is unnecessarily decreased).

In particular, in a case of an intermediate product or a lower limit product of the engine or the torque converter, a situation may occur in which engine performance is kept low. The situation may occur because the output torque is limited even though there is a margin up to a limit of the transmission (hardware). In other words, the performance is not fully exerted even though there is a margin.

Accordingly, there has been a desire to detect the torque to be inputted to the transmission (that is, the torque outputted from the engine and the torque converter) with higher accuracy, and to increase the torque as much as possible within a range not exceeding a hardware limit of the transmission (that is, a desire to decrease the margin as much as possible at a time of setting the allowable upper limit torque).

It is desirable to provide a transmission input torque control apparatus that makes it possible to obtain a torque outputted from an engine and a torque converter with higher accuracy and to increase the torque outputted from the engine and the torque converter and inputted to a transmission as much as possible within a range not exceeding a limit of the transmission (hardware) (that is, to decrease a margin to thereby increase an upper limit value of an input allowable torque as much as possible).

In the following, some example embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the disclosure are unillustrated in the drawings.

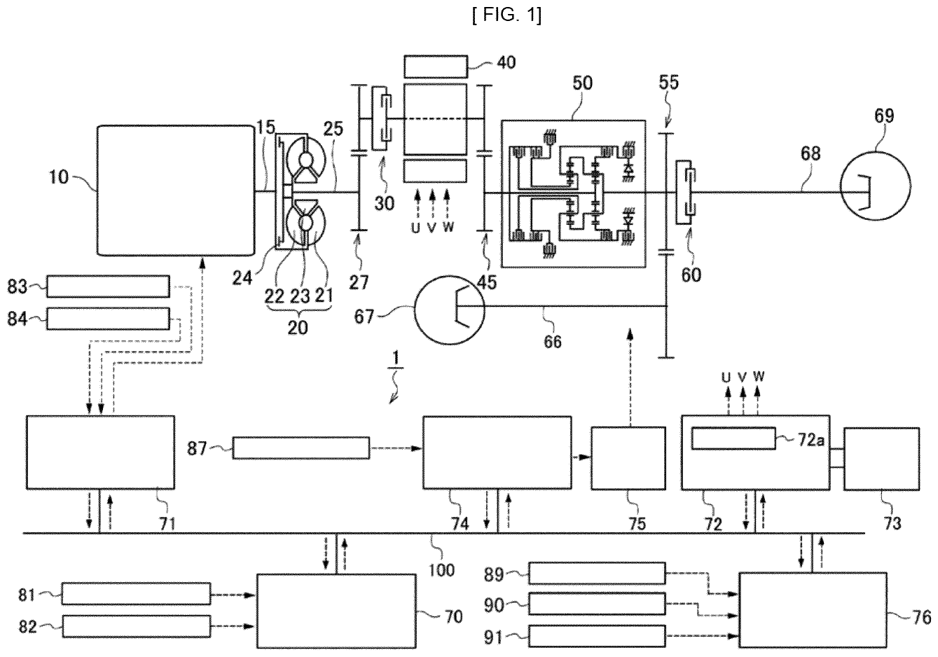

First, with reference to FIG. 1, a configuration of a transmission input torque control apparatus 1 according to an embodiment and a main part of a hybrid electric vehicle to which the transmission input torque control apparatus 1 is applied will be described. FIG. 1 is a block diagram illustrating the configuration of the transmission input torque control apparatus 1 and the main part of the hybrid electric vehicle to which the transmission input torque control apparatus 1 is applied.

An engine 10 may be of any type and is, for example, a horizontally opposed direct-injection four-cylinder gasoline engine. In the engine 10, intake air from an air cleaner (not illustrated) is throttled by an electronically controlled throttle valve provided in an intake pipe, passes through an intake manifold, and is taken into cylinders formed in the engine 10. Here, an amount of intake air from the air cleaner is detected by an air flow meter 83. Further, the throttle valve is provided with a throttle angle sensor that detects an opening degree of the throttle valve. An injector that injects fuel is attached to each cylinder. Further, an ignition plug and an igniter-built-in coil may be attached to each of the cylinders. The ignition plug ignites an air-fuel mixture. The igniter-built-in coil applies a high voltage to the ignition plug.

In each of the cylinders of the engine 10, the air-fuel mixture of the intake air and the fuel injected by the injector is ignited by the ignition plug and combusted. Exhaust gas after combustion is discharged through an exhaust pipe.

In addition to the air flow meter 83 and the throttle angle sensor described above, a cam angle sensor is attached near a camshaft of the engine 10. The cam angle sensor performs cylinder determination of the engine 10. In addition, a crank angle sensor 84 is attached near a crankshaft 15 of the engine 10. The crank angle sensor 84 detects a rotational position (a rotational speed) of the crankshaft 15. These sensors are coupled to an engine control unit (hereinafter referred to as an “ECU”) 71, which will be described later. In addition, various sensors such as a coolant temperature sensor are also coupled to the ECU 71. The coolant temperature sensor detects a temperature of a coolant of the engine 10.

A driving force (an engine torque) obtained by the combustion of the air-fuel mixture is outputted from the crankshaft 15. A torque converter 20 and an automatic transmission 50 are coupled to the crankshaft 15 of the engine 10. The torque converter 20 has a clutch function and a torque amplification function. The automatic transmission 50 is coupled to the crankshaft 15 of the engine 10 via, for example, a motor generator 40. The automatic transmission 50 converts the engine torque from the engine 10 and/or a motor torque from the motor generator 40 and outputs the converted engine torque and/or the converted motor torque.

The torque converter 20 mainly includes a pump impeller 21, a turbine runner 22, and a stator 23. The pump impeller 21 is coupled to the crankshaft 15 and generates an oil flow. The turbine runner 22 is disposed to be opposed to the pump impeller 21. The turbine runner 22 receives power from the engine 10 via the oil and drives a turbine shaft 25. The stator 23 is positioned between the pump impeller 21 and the turbine runner 22. The stator 23 rectifies the oil flow exhausted (returned) from the turbine runner 22 and returns the oil flow to the pump impeller 21, thereby causing a torque amplification effect.

In addition, the torque converter 20 includes a lock-up clutch 24 that brings an input and an output into a directly coupled state. When the lock-up clutch 24 is not engaged (in a non-lock-up state), the torque converter 20 performs torque amplification on the driving force of the engine 10 and outputs the amplified driving force. When the lock-up clutch 24 is engaged (during lock-up), the torque converter 20 directly outputs the driving force of the engine 10. A rotational speed (turbine rotational speed: output shaft rotational speed) of the turbine runner 22 included in the torque converter 20 is detected by a turbine rotation sensor 87. The detected turbine rotational speed is outputted to a transmission control unit (hereinafter referred to as a “TCU”) 74, which will be described later.

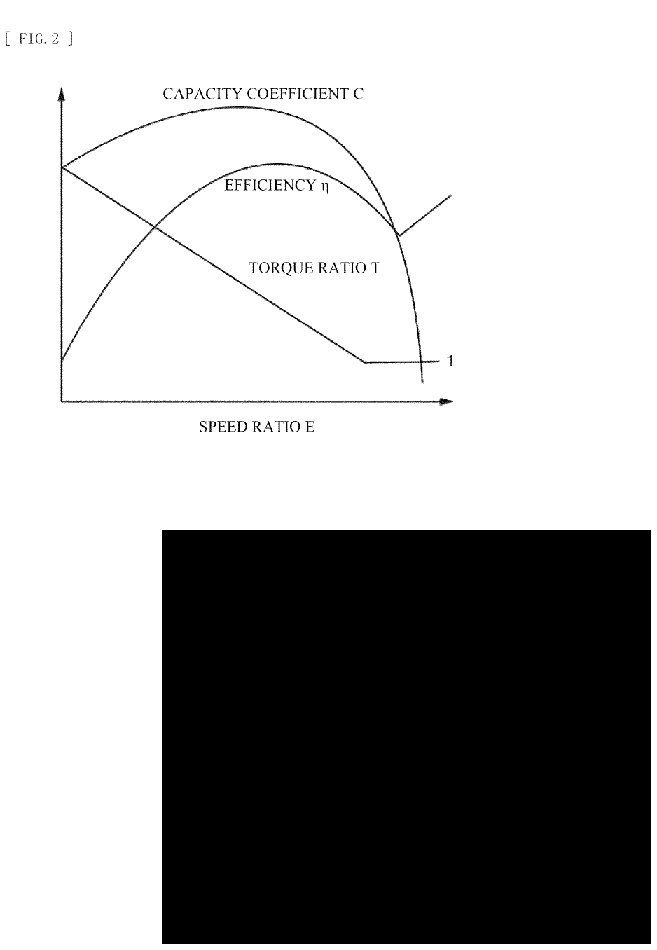

Here, an example of a performance curve (a torque characteristic) of the torque converter 20 is illustrated in FIG. 2. In FIG. 2, a horizontal axis represents a speed ratio, and a vertical axis represents each of characteristics including a torque ratio, efficiency, and a capacity coefficient (a torque capacity coefficient). The speed ratio, the torque ratio, the efficiency, and the capacity coefficient are obtained by the following respective expressions.

$$Speed ratio = output rotational speed / input shaft rotational speed \qquad ( 1 )$$

$$Torque ratio = output shaft torque / input shaft torque \qquad ( 2 )$$

$$Efficiency = torque ratio \times speed ratio \qquad ( 3 )$$

$$Capacity coefficient = input shaft torque / input shaft rotational {speed}^{2} \qquad ( 4 )$$

Further, the above expression (4) is modified to obtain the following expression (5).

$$Input shaft torque = capacity coefficient \times input shaft rotational {speed}^{2} \qquad ( 5 )$$

Similarly, the above expression (2) is modified to obtain the following expression (6).

$$Output shaft torque = torque ratio \times input shaft torque \qquad ( 6 )$$

Thereafter, the above expression (5) is substituted into the above expression (6), and the following expression (7) is obtained.

$$Output shaft torque = ( capacity coefficient \times torque ratio ) \times input shaft rotational {speed}^{2} \qquad ( 7 )$$

Further, the above expression (7) is modified to obtain the following expression (8).

$$( Capacity coefficient \times torque ratio ) = output shaft torque / input shaft rotational {speed}^{2} \qquad ( 8 )$$

Here, because an input shaft rotational speed is equal to an engine speed, it is possible to acquire a value of “capacity coefficient×torque ratio” (corresponding to a transmission characteristic described in claims) individually (per individual) by detecting an output shaft torque from a regenerative electric power generation amount (voltage×current) of the motor generator 40 (details will be described later).

The turbine shaft 25 of the torque converter 20 is coupled to the motor generator 40 via a pair of gears (a drive gear and a driven gear) 27 and an output clutch 30.

Here, the output clutch 30 is interposed between the torque converter 20 and the motor generator 40. The output clutch 30 interrupts or allows transmission of torque between the engine 10 and the torque converter 20 and the motor generator 40 (to drive wheels). The output clutch 30 is disengaged in order to disconnect the engine 10 and the torque converter 20 from wheels, for example, during coasting control, during EV traveling by the motor generator 40, and during regenerative braking by the motor generator 40.

However, even during, for example, coasting control, the output clutch 30 is engaged during learning, which will be described later. That is, during learning, the output clutch 30 is engaged to thereby cause the motor generator 40 to generate regenerative electric power by a torque outputted from the engine 10 and the torque converter 20, and the torque is obtainable from the electric power generation amount (details will be described later). Note that operations (engagement and disengagement) of the output clutch 30 is controlled by the TCU 74, which will be described later.

The motor generator 40 is configured as a synchronous generator-motor (a three-phase AC synchronous motor) that functions as both a motor that converts supplied electric power into mechanical power and a generator that converts inputted mechanical power into electric power. That is, the motor generator 40 operates as a motor that generates a drive torque when a vehicle is driven and operates as a generator during regeneration. The motor generator 40 is controlled by a hybrid electric vehicle control unit (hereinafter referred to as “HEV-CU”) 70, which will be described later.

The motor generator 40 is coupled to a high-voltage battery 73 via an inverter 72a. When the motor generator 40 functions as a motor, the inverter 72a converts DC power supplied from the high-voltage battery 73 into AC power and drives the motor generator 40. Further, when the motor generator 40 functions as a generator, the inverter 72a converts AC power generated by the motor generator 40 into DC power and charges the high-voltage battery 73. Here, as described above, the engine 10, the torque converter 20, and the motor generator 40 are coupled in series and are configured to make it possible that the torque outputted from the torque converter 20 is absorbed by the motor generator 40 through regeneration.

An output shaft of the motor generator 40 is coupled to an input shaft of the automatic transmission 50 via a reduction gear 45 including a pair of gears (a reduction drive gear and a reduction driven gear). The torque (the driving force) outputted from the engine 10 and/or the motor generator 40 is transmitted (inputted) to the automatic transmission 50 via the reduction gear 45.

The automatic transmission 50 converts an inputted torque and outputs the converted torque. Note that, in the present embodiment, a stepped automatic transmission (stepped AT) is used as the automatic transmission 50.

The automatic transmission 50 includes a transmission mechanism including a transmission gear train. In more detail, the transmission mechanism includes, for example, planetary gear sets and a friction engaging element. Each of the planetary gear sets includes, for example, a sun gear, a ring gear, and a pinion gear. The friction engaging element, such as clutches or a brake, switches (i.e., shifts) a power transmission path of the planetary gear sets. Accordingly, shifting of the automatic transmission 50 is performed by engaging or disengaging the friction engaging element such as the clutches (hereinafter, simply referred to as the “clutches or the like” or the “clutches”). Note that when all of the clutches are disengaged, the automatic transmission 50 is brought into a neutral state. Thus, it is possible to shut off torque inputted from the wheels (that is, to prevent the torque from being inputted to the motor generator 40) by, for example, automatically bringing the automatic transmission 50 into the neutral state at the time of learning, which will be described later.

Note that, as the automatic transmission 50, for example, a parallel two-shaft, stepped automatic transmission may be used instead of a planetary gear automatic transmission. The parallel two-shaft, stepped automatic transmission obtains a finite number of shifting steps by selectively switching combinations of gear trains provided on each of two shafts arranged in parallel by engaging and disengaging multiple wet clutches. In addition, instead of the stepped automatic transmission (stepped AT), for example, a continuously variable transmission (CVT) such as a chain-type CVT or a belt-type CVT, or a DCT (Dual Clutch Transmission) may be used. The DCT includes an independent clutch for each of shifting gear sets for an odd-numbered steps and an even-numbered steps, and the clutches are sequentially switched to perform shifting. Note that the continuously variable transmission includes, for example, a double pinion planetary gear train, a forward clutch, and a reverse brake. The continuously variable transmission is brought into the neutral state when the forward clutch and the reverse brake are disengaged. The forward clutch and the reverse brake configure a forward and reverse switching mechanism that switches between forward rotation and reverse rotation of the drive wheels (forward and reverse movement of the vehicle).

An output shaft of the automatic transmission 50 is coupled to a front drive shaft 66 via a counter gear 55 including a pair of gears (a counter drive gear and a counter driven gear). The driving force (the torque) outputted from the output shaft of the automatic transmission 50 is transmitted to a front differential (hereinafter also referred to as a “front diff”) 67 via the counter gear 55 and the front drive shaft 66. The front diff 67 is, for example, a bevel gear differential. The driving force from the front diff 67 is transmitted to a left front wheel via a left front wheel drive shaft and is transmitted to a right front wheel via a right front wheel drive shaft.

In contrast, a transfer clutch 60 is interposed in a latter stage of the counter gear 55 (the counter drive gear) on the output shaft described above. The transfer clutch 60 adjusts the driving force (the torque) to be transmitted to a rear differential (hereinafter, also referred to as a “rear diff”) 69. In the transfer clutch 60, an engagement force (that is, a torque distribution rate to rear wheels) is controlled in accordance with, for example, a driving state of four wheels (for example, a slip state of front wheels) and the engine torque. Thus, the driving force outputted from the output shaft of the automatic transmission 50 is distributed in accordance with the engagement force of the transfer clutch 60 to be also transmitted to the rear wheels.

More specifically, the transfer clutch 60 is coupled to a propeller shaft 68 extending rearward of the vehicle. Thus, the driving force (the torque) adjusted (distributed) by the transfer clutch 60 is transmitted to the rear diff 69 via the propeller shaft 68.

A left rear wheel drive shaft and a right rear wheel drive shaft are coupled to the rear diff 69. The driving force from the rear diff 69 is transmitted to a left rear wheel via the left rear wheel drive shaft and is transmitted to a right rear wheel via the right rear wheel drive shaft.

With the configuration described above, in the hybrid electric vehicle, it is possible to drive the wheels (the vehicle) by the two powers of the engine 10 and the motor generator 40. In addition, it is also possible to perform EV traveling and regeneration (power generation) using the motor generator 40.

More specifically, by configuring a driving force transmission system as described above, the torque of the engine 10 and/or the torque of the motor generator 40 is inputted to the input shaft of the automatic transmission 50. Thereafter, the torque converted by the automatic transmission 50 is outputted from the output shaft of the automatic transmission 50 and transmitted to the front drive shaft 66 via the counter gear 55. Thereafter, the torque is distributed to left and right by the front differential 67 to be transmitted to the left and right front wheels.

In contrast, some of the torque outputted from the automatic transmission 50 is transmitted to the propeller shaft 68 via the transfer clutch 60. Here, when a predetermined clutch torque is applied to the transfer clutch 60, the torque distributed in accordance with the clutch torque is outputted to the propeller shaft 68. Thereafter, the torque is also transmitted to the rear wheels via the rear diff 69.

The engine 10 and the motor generator 40, which are driving sources of the vehicle, and the automatic transmission 50 are comprehensively controlled by a control system including, for example, the HEV-CU 70 (corresponding to a control unit described in the claims), the ECU 71, a power control unit (hereinafter referred to as a “PCU”) 72, the TCU 74, and a vehicle dynamics control unit (hereinafter referred to as a “VDCU”) 76.

Each of the HEV-CU 70, the ECU 71, the PCU 72, the TCU 74, and the VDCU 76 includes a microprocessor that performs computation, a EEPROM that stores, for example, programs that cause the microprocessor to execute processes, a RAM that stores various kinds of data such as a result of the computation, an input and output I/F, and the like.

Each of the HEV-CU 70, the ECU 71, the PCU 72, the TCU 74, and the VDCU 76 is communicably coupled to each other via a CAN (Controller Area Network) 100.

Various sensors including, for example, an accelerator pedal sensor 81 and a resolver 82 are coupled to the HEV-CU 70. The accelerator pedal sensor 81 detects a depression amount of an accelerator pedal, that is, a position of the accelerator pedal. The resolver 82 detects a rotational position (a rotational speed) of the motor generator 40. Further, the HEV-CU 70 receives, via the CAN 100, various kinds of information including, for example, the engine speed, the turbine rotational speed (an output shaft rotational speed), the regenerative electric power generation amount, an operating amount of the brake, a steering angle of a steering wheel, and a yaw rate from the ECU 71, the PCU 72, the TCU 74, the VDCU 76, and the like.

The HEV-CU 70 comprehensively controls driving of the engine 10, the motor generator 40, and the automatic transmission 50 based on the acquired various kinds of information. The HEV-CU 70 obtains a requested torque of the engine 10, a torque command value of the motor generator 40, and a target shifting ratio of the automatic transmission 50 based on various kinds of information including, for example, the position of the accelerator pedal (a requested torque of a driver), the engine speed, a motor rotational speed, an operating state of the vehicle (a vehicle speed, the steering angle, etc.), a regenerative braking amount, and a state of charge (SOC) of the high-voltage battery 73. Thereafter, the HEV-CU 70 outputs, for example, the requested torque, the torque command value, and the target shifting ratio that have been obtained via the CAN 100. Further, the HEV-CU 70 acquires an actual motor torque of the motor generator 40 and transmits the actual motor torque to the TCU 74 via the CAN 100.

In the ECU 71, the cylinder is determined from an output of the above-described cam angle sensor, and the engine speed (a rotational speed) is obtained from changes in the rotational position of the crankshaft 15 detected based on an output of the crank angle sensor 84. Further, the ECU 71 acquires various kinds of information including, for example, the amount of intake air, the position of the accelerator pedal, an air-fuel ratio of the air-fuel mixture, and a coolant temperature based on detection signals inputted from the various sensors described above. Thereafter, the ECU 71 controls the engine 10 by controlling a fuel injection amount, ignition timing, and various devices such as an electronically controlled throttle valve based on the various kinds of information that have been acquired and the requested torque (or a requested rotational speed) from the HEV-CU 70. Note that the ECU 71 stops fuel injection to the engine 10 (performs fuel cutting) during coasting control. However, the fuel injection is not stopped during learning, which will be described later.

Further, the ECU 71 calculates an actual engine torque (an output torque) of the engine 10 based on, for example, the amount of intake air detected by the air flow meter 83 and the engine speed. Thereafter, the ECU 71 transmits information including, for example, the engine speed (the rotational speed) and the actual engine torque to the TCU 74, the HEV-CU 70, and the like via the CAN 100.

The PCU 72 drives the motor generator 40 via the inverter 72a based on the torque command value from the HEV-CU 70. Here, the inverter 72a converts the DC power of the high-voltage battery 73 into a three-phase AC power and supplies the converted power to the motor generator 40. In contrast, during regeneration for example, the inverter 72a converts an AC voltage generated by the motor generator 40 into a DC voltage to charge the high-voltage battery 73. Note that, at this time, in the PCU 72, the electric power generation amount (the current and the voltage) during regeneration is detected and transmitted to the HEV-CU 70.

A brake switch 89 and a brake fluid pressure sensor 90 are coupled to the VDCU 76. The brake switch 89 detects whether a brake pedal is depressed. The brake fluid pressure sensor 90 detects a master cylinder pressure (a brake fluid pressure sensor) of a brake actuator. In addition, for example, wheel speed sensors 91 are coupled to the VDCU 76. The wheel speed sensors 91 detect rotational speeds (the vehicle speed) of respective wheels of the vehicle.

The VDCU 76 brakes the vehicle by driving the brake actuator in accordance with an operating amount (a depression amount) of the brake pedal, detects a behavior of the vehicle by various sensors (for example, the wheel speed sensors 91, a steering angle sensor, an acceleration sensor, and a yaw rate sensor), and suppresses side slip by brake control based on automatic pressurization and torque control of the engine 10 and the like. This secures vehicle stability at a time of turning. In addition, the VDCU 76 has both an anti-lock brake function (an ABS function) and a traction control function (a TCS function). The ABS function secures directional stability and steerability during braking and obtains an optimal braking force by preventing wheels from being locked upon abrupt braking or upon braking on a slippery road surface to maintain a slip rate of each of the wheels to be appropriate. The TCS function secures stability and acceleration of the vehicle at a time of starting and accelerating by suppressing idling of the drive wheels caused by the slippery road surface or an excessive driving force.

The VDCU 76 transmits, for example, braking information (brake operation information) on the brake switch 89, the brake fluid pressure, etc., and a wheel speed (the vehicle speed) that have been detected to the TCU 74, the HEV-CU 70, the ECU 71, and the like via the CAN 100.

The above-described turbine rotation sensor 87 and the like are coupled to the TCU 74. The TCU 74 transmits the detected turbine rotational speed (the output shaft rotational speed) and the like to the HEV-CU 70 and other devices via the CAN 100.

Further, the TCU 74 receives, via the CAN 100, information such as the actual engine torque from the ECU 71, information including, for example, the actual motor torque and the position of the accelerator pedal from the HEV-CU 70, and information including, for example, the vehicle speed and the braking operation from the VDCU 76.

The TCU 74 changes a shifting ratio (a shifting step) of the automatic transmission 50 based on the acquired various kinds of information (the operating state of the vehicle) and the target shifting ratio from the HEV-CU 70.

At this time, the TCU 74 controls driving of a solenoid valve (an electromagnetic valve) included in a control valve 75 to adjust a hydraulic pressure to be supplied to the automatic transmission 50, thereby changing the shifting ratio (the shifting step) of the automatic transmission 50.

In addition, the TCU 74 controls driving of a solenoid valve included in the control valve 75 to adjust a hydraulic pressure to be supplied to the transfer clutch 60 (i.e., adjusts the engagement force), thereby adjusting the distribution ratio of the driving force to be transmitted to the rear wheels. Further, the TCU 74 controls driving of a solenoid valve included in the control valve 75 to control engagement and disengagement of the output clutch 30. At the time of learning, which will be described later, the TCU 74 brings the automatic transmission 50 into the neutral state in accordance with a request (a command) from the HEV-CU 70. The TCU 74 also engages the output clutch 30 and disengages the lock-up clutch 24.

Here, the HEV-CU 70 obtains the torque outputted from the engine 10 and the torque converter 20 with higher accuracy, and has a function of increasing the torque outputted from the engine 10 and the torque converter 20 and inputted to the automatic transmission 50 as much as possible within a range not exceeding a limit of the automatic transmission 50 (hardware) (that is, a function of decreasing a margin to thereby increase an upper limit value of an input allowable torque as much as possible). In the HEV-CU 70, the corresponding one of the programs stored in, for example, the EEPROM is executed by the microprocessor to implement the function.

First, when a predetermined learning condition is satisfied (the time of learning), the HEV-CU 70 engages (requests the TCU 74 to engage) the output clutch 30 interposed between the torque converter 20 and the motor generator 40. In addition, when the predetermined learning condition is satisfied (the time of learning), the HEV-CU 70 sets (requests the TCU 74 to set) the automatic transmission 50 to the neutral state. Further, the HEV-CU 70 disengages (requests the TCU 74 to disengage) the lock-up clutch 24 of the torque converter 20. This makes it possible to shut off the torque from the wheels, and cause the motor generator 40 to absorb (regenerate) all the torques outputted from the engine 10 and the torque converter 20.

Here, the predetermined learning condition includes, for example, whether the requested torque of the driver determined based on an operating amount (the depression amount) of the accelerator pedal is zero or substantially zero (accelerator-off), and the automatic transmission 50 is in a state allowable to be brought into neutral. Specific examples of the predetermined learning condition includes that the vehicle is stopped (in a P range or at a time of braking to stop in a D range) and that the vehicle is coasting (at a time of traveling in an accelerator-off state and a brake-off state).

Note that, in a case of performing regeneration (power generation) during stopping, increasing the engine speed may possibly give a sense of discomfort to the driver and increase noise inside and outside the vehicle (or noise may possibly become a problem). In contrast, when the vehicle speed is high to some extent during coasting, issues such as noise become relatively small. This allows for measurement (learning) at a higher engine speed. Further, a configuration may be adopted in which it is possible to perform measurement (learning) during, for example, maintenance (by providing a maintenance mode).

Next, when the predetermined learning condition is satisfied, the HEV-CU 70 causes the motor generator 40 to perform a regenerative operation, detects an output torque of the torque converter 20 from the regenerative electric power generation amount of the motor generator 40, obtains a value of “capacity coefficient×torque ratio” of the torque converter 20 based on the output torque and the engine speed at a time of detection (using the above expression (8)), and learns the value. Here, because it is possible to accurately measure the voltage and the current, it is possible to accurately measure the regenerative electric power generation amount of the motor generator 40.

Incidentally, because “capacity coefficient×torque ratio” depends on the speed ratio of the torque converter 20, the HEV-CU 70 controls (varies) the rotational speed of the engine 10 to acquire multiple learned values at given speed ratios, thus acquiring multiple learned values in a range of, for example, speed ratios of about 0 to 0.6. That is, the HEV-CU 70 changes the engine speed to vary the speed ratio of the torque converter 20 during learning, thereby causing the motor generator 40 to perform the regenerative operation at multiple speed ratios. The HEV-CU 70 detects output torques of the torque converter 20 from regenerative electric power generation amounts of the motor generator 40. Thereafter, a value of “capacity coefficient×torque ratio” with respect to each of the speed ratios of the torque converter 20 is obtained based on the corresponding output torque and the engine speed at a time of detection (using the above expression (8)), and the obtained value is learned.

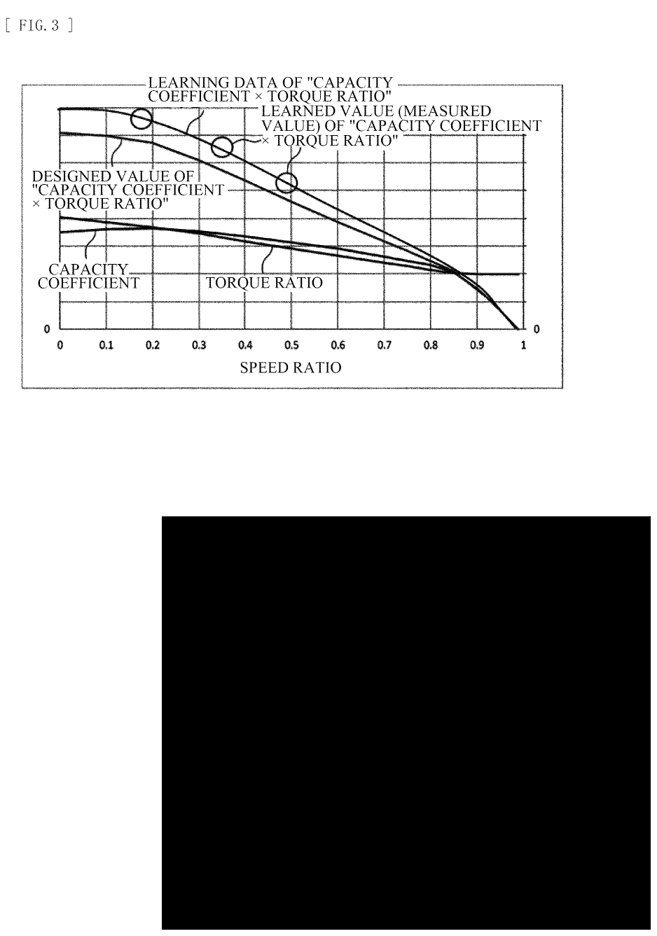

Thereafter, the HEV-CU 70 performs curve fitting of multiple learned values acquired at the multiple speed ratios taking into consideration a designed value of the torque converter 20, thereby acquiring learning data (a learning characteristic curve) of “capacity coefficient×torque ratio” with respect to the speed ratio. For example, as illustrated in FIG. 3, the learning data (the learning characteristic curve) of “capacity coefficient×torque ratio” with respect to individual speed ratios (per individual) is acquired from three learned values (circles) by performing curve fitting. Here, FIG. 3 is a graph that describes how to obtain the learning data (the learning characteristic curve) of “capacity coefficient×torque ratio” with respect to the speed ratio. In FIG. 3, a horizontal axis represents the speed ratio, and a vertical axis represents the capacity coefficient, the torque ratio, and the designed value and the learned value of “capacity coefficient×torque ratio”.

Here, it is possible to accurately perform curve fitting with a smaller number of learned values by taking into consideration the designed value of the torque converter 20. Note that for the curve fitting, it is possible to use a known method including, for example, a least squares method. In addition, the acquired learning data is stored in a memory such as the EEPROM.

Thereafter (after learning), the HEV-CU 70 estimates an input torque of the automatic transmission 50 from the above expression (7) based on the learned value of “capacity coefficient×torque ratio” corresponding to the speed ratio in real time (during control) and the engine speed in real time (during control).

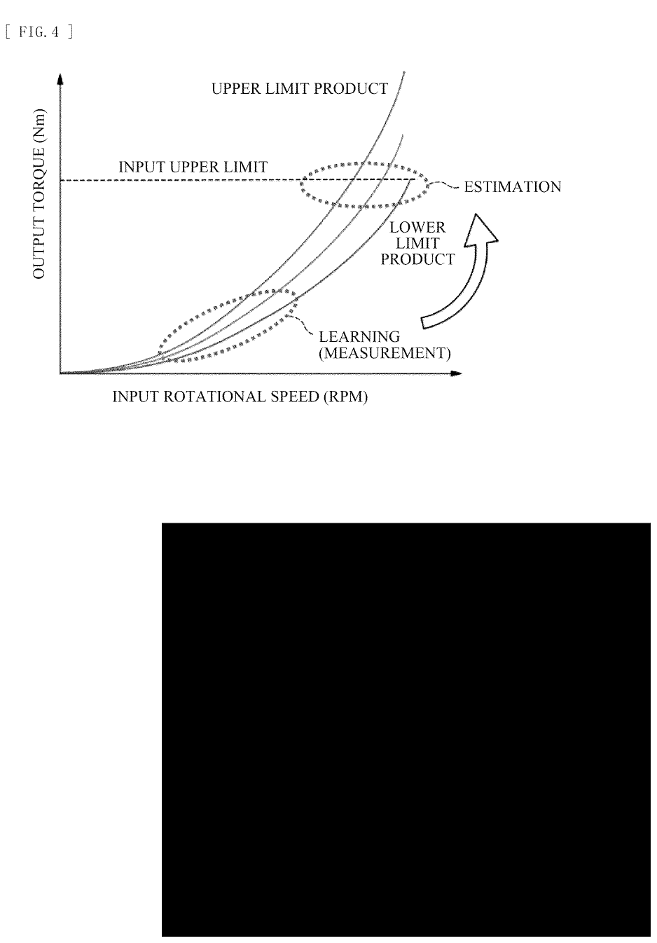

Here, because it is difficult to measure (learn) up to a high load region (a high engine speed) during learning, as illustrated in FIG. 4, an output torque at a high load (a high rotation) is estimated from a measured value (the learned value) at a low load (a low rotation) using the above expression (7). FIG. 4 is a graph that describes a method of estimating the output torque using the learning data. In FIG. 4, a horizontal axis represents an input rotational speed (=the engine speed) of the torque converter 20, and a vertical axis represents the output torque of the torque converter 20.

Note that, at this time, the HEV-CU 70 estimates the torque to be inputted to the automatic transmission 50 by taking into consideration a gear ratio of the reduction gear 45 between the motor generator 40 and the automatic transmission 50, and the torque (power running or regeneration) of the motor generator 40.

Thereafter, the HEV-CU 70 so controls (requests the ECU 71 to so control) the engine 10 (the engine speed) that an estimated input torque does not exceed the upper limit value of the input allowable torque of the automatic transmission 50.

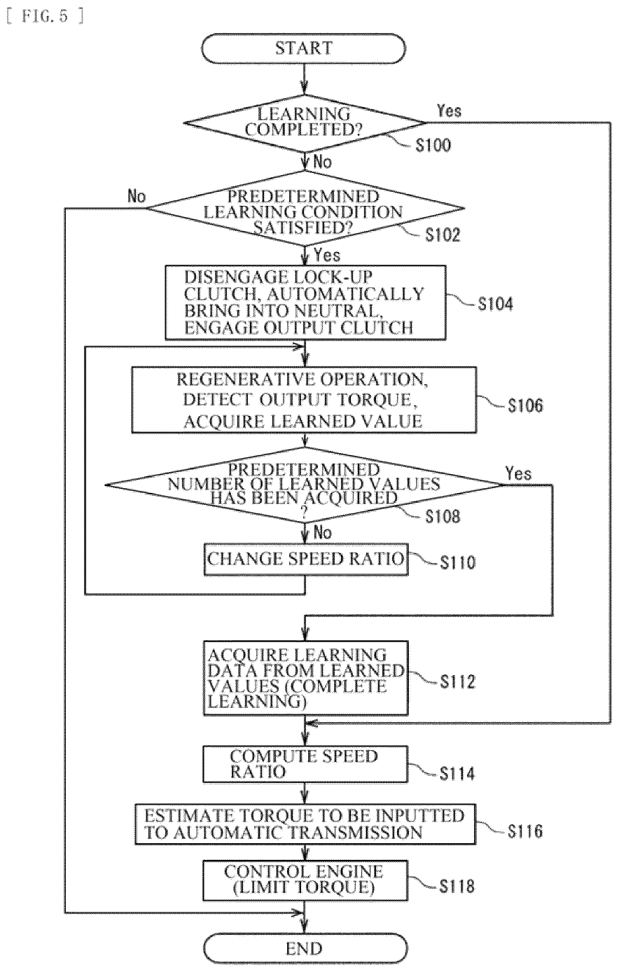

Next, operation of the transmission input torque control apparatus 1 will be described with reference to FIG. 5. Here, FIG. 5 is a flowchart illustrating a processing procedure of a transmission input torque control (a learning process, an input torque estimation process, and an input torque limiting process) performed by the transmission input torque control apparatus 1. The process is repeatedly executed mainly by the HEV-CU 70 at a predetermined timing.

First, in step S100, it is determined whether the learning has already been completed. Here, when the learning has already been completed, the process is caused to proceed to step S114, which will be described later. In contrast, when the learning has not been completed yet, the process is caused to proceed to step S102.

In step S102, it is determined whether the predetermined learning condition is satisfied. Here, when the predetermined learning condition is not satisfied, the process ends once. In contrast, when the predetermined learning condition is satisfied, the process is caused to proceed to step S104. Note that the predetermined learning condition is as described above, and detailed description thereof will be omitted here.

In step S104, the lock-up clutch 24 of the torque converter 20 is disengaged (requested the TCU 74), the output clutch 30 is engaged (requested the TCU 74), and the automatic transmission 50 is brought into the neutral state (requested the TCU 74).

Subsequently, in step S106, the motor generator 40 performs the regenerative operation, the torque outputted from the torque converter 20 is detected from the regenerative electric power generation amount of the motor generator 40, the value of “capacity coefficient×torque ratio” of the torque converter 20 is obtained based on the output torque and the engine speed at the time of detection (using the above expression (8)), and the obtained value is learned.

Next, in step S108, it is determined whether a predetermined number of (for example, three) learned values has been acquired by changing the speed ratio. Here, when the predetermined number of learned values has not been acquired yet, the engine speed (i.e., the speed ratio) is changed in step S110, and thereafter the processes of steps S106 to S108 described above are repeatedly executed until the predetermined number of learned values is acquired. That is, at each of multiple speed ratios, the torque outputted from the torque converter 20 is detected from the regenerative electric power generation amount of the motor generator 40, and the value of “capacity coefficient×torque ratio” with respect to the speed ratio of the torque converter 20 is obtained based on the output torque and the engine speed at the time of detection (using the above expression (8)), and the obtained value is learned.

In contrast, when the predetermined number of learned values is acquired, the process is caused to proceed to step S112. In step S112, the learned values acquired at the multiple speed ratios are subjected to curve fitting taking into consideration the designed value of the torque converter 20. The learning data (a characteristic curve after learning) of “capacity coefficient×torque ratio” with respect to the speed ratio is acquired and stored as, for example, a map.

Next, in step S114, the turbine rotational speed (the output shaft rotational speed) and the engine speed (the input shaft rotational speed) in real time (during control) are read, and the speed ratio (output shaft rotational speed/input shaft rotational speed) in real time is obtained from the turbine rotational speed and the engine speed. Note that the output shaft rotational speed may be obtained from the motor rotational speed.

In the following step S116, the speed ratio in real time obtained in step S114 is used to retrieve the learning data stored as, for example, the map in step S112, and the learned value of “capacity coefficient×torque ratio” corresponding to the speed ratio is acquired. Thereafter, based on the learned value and the engine speed in real time, the torque to be inputted to the automatic transmission 50 is estimated using the above expression (7).

Thereafter, in step S118, the engine 10 (engine speed) is so controlled that the estimated input torque obtained in step S116 does not exceed the upper limit value of the input allowable torque of the automatic transmission 50. Thereafter, the process ends once.

As described above in detail, according to the present embodiment, when the predetermined learning condition is satisfied, the motor generator 40 performs the regenerative operation, the output torque of the torque converter 20 is detected from the regenerative electric power generation amount of the motor generator 40, and the value of “capacity coefficient×torque ratio” of the torque converter 20 is learned based on the output torque and the engine speed at the time of detection. After learning, the torque to be inputted to the automatic transmission 50 is estimated based on the learned value of “capacity coefficient×torque ratio” and the engine speed in real time, and the engine 10 is so controlled that the estimated input torque does not exceed the upper limit value of the input allowable torque of the automatic transmission 50. Here, because it is possible to accurately detect the electric power generation amount (a current value and a voltage value) of the motor generator 40, it is possible to accurately detect the torque outputted from the engine 10 and the torque converter 20. Further, because it is also possible to accurately detect the engine speed, it is possible to accurately obtain (learn) “capacity coefficient×torque ratio” of the individual torque converter 20 (per individual). This makes it possible to thereafter accurately obtain the torque outputted from the engine 10 and the torque converter 20 based on the learned value and the engine speed in real time.

As a result, according to the present embodiment, when the vehicle is driven by the engine 10 (including the engine 10 and the motor generator 40), it is possible to more accurately obtain the torque outputted from the engine 10 and the torque converter 20. This makes it possible to increase the torque outputted from the engine 10 and the torque converter 20 and inputted to the automatic transmission 50 as much as possible within a range not exceeding the limit of the automatic transmission 50 (hardware) (that is, to decrease the margin to thereby increase the upper limit value of the input allowable torque as much as possible). In addition, as a result, it is possible to improve the engine performance by using up a torque limit of the automatic transmission 50 at the time of, for example, hill start or traveling over a level difference.

In particular, according to the present embodiment, during learning, the rotational speed of the engine 10 is changed to vary the speed ratio of the torque converter 20. The output torque of the torque converter 20 is detected from the regenerative electric power generation amount of the motor generator 40 at each of multiple speed ratios. The learned value for each of the multiple speed ratios is acquired based on the corresponding output torque and the engine speed at the time of detection. Further, at this time, the multiple learned values learned at the multiple speed ratios are subjected to curve fitting taking into consideration the designed value of the torque converter 20 to thereby acquire the learning data of “capacity coefficient×torque ratio” with respect to the speed ratio. After learning, the input torque of the automatic transmission 50 is estimated based on the learned value of “capacity coefficient×torque ratio” corresponding to the speed ratio in real time and the engine speed in real time, and the engine 10 is so controlled that the estimated input torque does not exceed the upper limit value of the input allowable torque of the automatic transmission 50. As described above, performing learning (torque measurement) by changing the speed ratio makes it possible to accurately estimate the torque in a high rotation region (a high torque region). In addition, it is thus possible to increase the detection accuracy of the torque outputted from the torque converter 20 and decrease the margin in setting the upper limit value of the input allowable torque. This makes it possible to use up the torque limit of the automatic transmission 50.

According to the present embodiment, the predetermined learning condition includes whether the requested torque of the driver determined based on the operating amount of the accelerator pedal is zero or substantially zero, and the automatic transmission 50 is allowable to be brought into the neutral state. When the predetermined learning condition is satisfied (that is, at the time of learning), the automatic transmission 50 is automatically brought into the neutral state. Thus, it is possible to shut off the torque inputted to the motor generator 40 from the wheels, and detect only the torque outputted from the engine 10 and the torque converter 20. Further, it is possible to measure the output torque without giving a sense of discomfort to the driver (without changing the driving torque of the wheels).

Further, according to the present embodiment, the output clutch 30 interposed between the torque converter 20 and the motor generator 40 is provided, and the output clutch 30 is engaged during learning. Thus, during EV traveling, during normal regeneration (other than at the time of learning), and during normal coasting (other than at the time of learning), the output clutch 30 is disengaged to disconnect the engine 10 and the torque converter 20 to thereby reduce dragging (friction), whereas during learning, the output clutch 30 is engaged to cause the motor generator 40 to perform regeneration by the torque outputted from the engine 10 and the torque converter 20. It is possible to obtain the torque from the electric power generation amount of the regeneration.

Further, according to the present embodiment, the input torque of the automatic transmission 50 is estimated further taking into consideration the gear ratio of the reduction gear 45 interposed between the motor generator 40 and the automatic transmission 50, and the torque (power running or regeneration) of the motor generator 40. This makes it possible to more accurately detect and control the torque inputted to the automatic transmission 50.

Although embodiments of the disclosure have been described in the foregoing, the disclosure is not limited to the above-described embodiments and various modifications may be made. For example, in the above embodiments, an example has been described in which the disclosure is applied to an AWD vehicle (all-wheel drive vehicle), but the disclosure may also be applied to, for example, a 2WD vehicle. Further, the type and the mechanism of the automatic transmission 50 are not limited to the above-described embodiments. For example, the disclosure may be applied to other types of transmissions such as a continuously variable transmission (CVT) or a DCT (Dual Clutch Transmission) instead of the stepped automatic transmission (stepped AT).

In addition, a system configuration of controllers including, for example, the HEV-CU 70, the ECU 71, and the TCU 74 and sharing or the like of the function of each of the controllers are not limited to the above-described embodiments. For example, in the above-described embodiments, the controllers including, for example, the HEV-CU 70, the ECU 71, and the TCU 74 are communicably coupled to each other via the CAN 100; however, the configuration of the system is not limited to such a form, and may be changed (integrated, etc.) as desired taking into consideration functional requirements, costs, and the like. Further, a configuration in which the VDCU 76 is not provided may be employed.

In the above-described embodiment, the output clutch 30 and the transfer clutch 60 are hydraulic clutches, but an electromagnetic clutch, for example, may be used.

According to the disclosure, it is possible to obtain a torque outputted from the engine and the torque converter with higher accuracy, and it is possible to increase the torque outputted from the engine and the torque converter and inputted to the transmission as much as possible within the range not exceeding the limit of the transmission (hardware) (that is, to decrease the margin to thereby increase the upper limit value of the input allowable torque as much as possible).

The HEV-CU 70 illustrated in FIG. 1 is implementable by circuitry including at least one semiconductor integrated circuit such as at least one processor (e.g., a central processing unit (CPU)), at least one application specific integrated circuit (ASIC), and/or at least one field programmable gate array (FPGA). At least one processor is configurable, by reading instructions from at least one machine readable non-transitory tangible medium, to perform all or a part of functions of the HEV-CU 70 illustrated in FIG. 1. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the nonvolatile memory may include a ROM and a NVRAM. The ASIC is an integrated circuit (IC) customized to perform, and the FPGA is an integrated circuit designed to be configured after manufacturing in order to perform, all or a part of the functions of the HEV-CU 70 illustrated in FIG. 1.

1. A transmission input torque control apparatus comprising:
an engine configured to output an engine torque;
a torque converter coupled to an output shaft of the engine, and configured to transmit the engine torque via oil and perform torque amplification;
a motor generator that is coupled to an output shaft of the torque converter, and configured to operate as a motor that outputs a motor torque upon driving, and operate as a generator upon regeneration;
an automatic transmission that is coupled to an output shaft of the motor generator, and configured to convert an inputted torque and output the converted torque; and
a control unit configured to control the engine, the torque converter, the motor generator, and the automatic transmission, wherein
the control unit is configured to
when a predetermined learning condition is satisfied, cause the motor generator to perform a regenerative operation, detect an output torque of the torque converter from a regenerative electric power generation amount of the motor generator, and perform learning of, based on the output torque and an engine speed at a time of detection, a value of a transmission characteristic of the torque converter, and
after the learning, estimate a torque to be inputted to the automatic transmission based on the learned value of the transmission characteristic of the torque converter and an engine speed in real time, and so control the engine that the estimated input torque does not exceed an upper limit value of an input allowable torque of the automatic transmission.

2. The transmission input torque control apparatus according to claim 1, wherein the transmission characteristic of the torque converter comprises “capacity coefficient×torque ratio” of the torque converter.

3. The transmission input torque control apparatus according to claim 2, wherein
the predetermined learning condition comprises whether a requested torque of a driver determined based on an operating amount of an accelerator pedal is zero or substantially zero, and the automatic transmission is in a state allowable to be brought into a neutral state, and
the control unit automatically brings the automatic transmission into the neutral state when the predetermined learning condition is satisfied.

4. The transmission input torque control apparatus according to claim 3, wherein
the control unit is configured to
upon the learning, disengage a lock-up clutch of the torque converter, change a speed ratio that is a ratio between an input rotational speed and an output rotational speed of the torque converter, cause the motor generator to perform a regenerative operation at multiple speed ratios, detect output torques of the torque converter from regenerative electric power generation amounts of the motor generator, and perform learning of a value of “capacity coefficient×torque ratio” with respect to each of the speed ratios of the torque converter based on the corresponding output torque and the engine speed at a time of detection, and
after the learning, estimate an input torque of the automatic transmission based on the learned value of “capacity coefficient×torque ratio” corresponding to a speed ratio in real time and an engine speed in real time, and so control the engine that the estimated input torque does not exceed the upper limit value of the input allowable torque of the automatic transmission.

5. The transmission input torque control apparatus according to claim 4, wherein the control unit is configured to acquire learning data of “capacity coefficient×torque ratio” with respect to the speed ratio by subjecting the multiple learned values acquired at the multiple speed ratios to curve fitting taking into consideration a designed value of the torque converter.

6. The transmission input torque control apparatus according to claim 5, further comprising a clutch interposed between the torque converter and the motor generator, wherein
the control unit is configured to engage the clutch upon the learning.

7. The transmission input torque control apparatus according to claim 6, wherein the control unit is configured to estimate the input torque of the automatic transmission taking into consideration a gear ratio between the motor generator and the automatic transmission, and a torque of the motor generator.

8. A transmission input torque control apparatus comprising:
an engine configured to output an engine torque;
a torque converter coupled to an output shaft of the engine, and configured to transmit the engine torque via oil and perform torque amplification;
a motor generator that is coupled to an output shaft of the torque converter, and configured to operate as a motor that outputs a motor torque upon driving, and operate as a generator upon regeneration;
an automatic transmission that is coupled to an output shaft of the motor generator, and configured to convert an inputted torque and output the converted torque; and
circuitry configured to control the engine, the torque converter, the motor generator, and the automatic transmission, wherein
the circuitry is configured to
when a predetermined learning condition is satisfied, cause the motor generator to perform a regenerative operation, detect an output torque of the torque converter from a regenerative electric power generation amount of the motor generator, and perform learning of, based on the output torque and an engine speed at a time of detection, a value of a transmission characteristic of the torque converter, and
after the learning, estimate a torque to be inputted to the automatic transmission based on the learned value of the transmission characteristic of the torque converter and an engine speed in real time, and so control the engine that the estimated input torque does not exceed an upper limit value of an input allowable torque of the automatic transmission.
